(19) United States
(12) Patent Application Publication
(10) Pub. No.: US 2026/0008260 A1
(43) Pub. Date: Jan. 8, 2026

(54) SYSTEMS AND METHODS FOR BONDING NANOFIBERS

(71) Applicant: Nibertex Pte Ltd, Singapore (SG)

(72) Inventors: Jaehyung PARK, Bacoor (PH); Jaemin PARK, Bacoor (PH); Jongman PARK, Bacoor (PH); Sunggun KWON, Seoul (KR)

(21) Appl. No.: 19/251,463

(22) Filed: Jun. 26, 2025

Related U.S. Application Data
(60) Provisional application No. 63/667,346, filed on Jul. 3, 2024.

(51) Int. Cl. B32B 37/00; B32B 37/10; B32B 37/15

(52) U.S. Cl. CPC B32B 37/025; B32B 37/10; B32B 37/15; B32B 2305/026; B32B 2307/7376

(57) ABSTRACT

Embodiments described herein relate to methods of producing coupled porous films. In some aspects, a method can include disposing a first porous material onto a first carrier member, and coupling the first porous material to a second porous material to obtain a coupled porous material. The method further includes removing the first carrier member from the coupled porous material to obtain a coupled porous film. The method may also include disposing the second porous material onto a second carrier member prior to coupling the first porous material to the second porous material, and removing the second carrier member from the coupled porous material.

### CROSS-REFERENCE TO RELATED APPLICATIONS

This application claims priority to and the benefit of U.S. Provisional Patent Application No. 63/667,346, filed Jul. 3, 2024, and entitled, “Systems and Methods for Bonding Nanofibers,” the entire disclosure of which is hereby incorporated by reference herein.

### TECHNICAL FIELD

Embodiments described herein relate generally to the manufacturing of multi-layered materials, specifically multi-layered porous films including two or more layers of nanofibers coupled together.

### BACKGROUND

Multi-layered materials, such as laminate films formed from nanofibers, play a crucial role in various industries due to their remarkable mechanical properties, lightweight nature, and enhanced functionality. In traditional manufacturing processes, nanofibers are electrospun onto a carrier member to form a thin film of nanofibers (e.g., a nanofiber web having a plurality of pores). After the electrospun nanofibers are separated from the carrier member, these nanofibers go through a laminating process where multiple layers of nanofibers are bonded together to achieve a certain thickness.

One of the challenges during lamination is the separation of the thin nanofibers with diameters ranging from a few nanometers up to micrometers from the carrier member. The thinness of the nanofibers often causes them to stick to the carrier member and become damaged. Therefore, after separating the nanofibers from the carrier member, there is a process to inspect the nanofibers and repair or cut out damaged areas. This separation, inspection, and repair process consumes a significant amount of processing time, increases manufacturing costs, and also has a considerable negative impact on product quality. Furthermore, the nanofibers can be easily damaged during the separation of the thin nanofiber film from the carrier member. Thus, post-processing operations may have to be performed for treating and/or repairing the damaged sections of nanofibers further increasing manufacturing complexity, time, and cost.

### SUMMARY

Embodiments described herein pertain to systems and methods for manufacturing multi-layered porous materials including two or more layers of nanofibers adhered together to achieve a predetermined thickness.

Embodiments described herein relate to methods of producing a coupled porous film. In some aspects, a method can include disposing a first porous material onto a first carrier member, and coupling the first porous material to a second porous material to obtain a coupled porous material. The method further includes removing the first carrier member from the coupled porous material to obtain a coupled porous film. The method may also include disposing the second porous material onto a second carrier member prior to coupling the first porous material to the second porous material. In some cases, the method further includes removing the second carrier member from the coupled porous material.

In some aspects, a method includes: disposing a first porous material onto a first carrier member; disposing a second porous material onto a second carrier member; coupling the first porous material to a second porous material to obtain a coupled porous material; removing the first carrier member from the coupled porous material; and removing the second carrier member from the coupled porous material to obtain a coupled porous film.

### BRIEF DESCRIPTION OF THE DRAWINGS

The foregoing and other features of the present disclosure will become more fully apparent from the following description and appended claims, taken in conjunction with the accompanying drawings. Understanding that these drawings depict only several implementations in accordance with the disclosure and are therefore, not to be considered limiting of its scope, the disclosure will be described with additional specificity and detail through use of the accompanying drawings. Optional items in all figures shown in dashed lines.

FIG. 1 is a schematic flow chart of a method of producing a coupled porous film, according to an embodiment.

FIG. 2 shows an illustration of a system for manufacturing a coupled porous film, according to an embodiment.

FIG. 3 shows an illustration of a system for manufacturing a coupled porous film, according to an embodiment.

FIG. 4 is a block diagram of a method for producing a coupled porous film, according to an embodiment.

Reference is made to the accompanying drawings throughout the following detailed description. In the drawings, similar symbols typically identify similar components, unless context dictates otherwise. The illustrative implementations described in the detailed description, drawings, and claims are not meant to be limiting. Other implementations may be utilized, and other changes may be made, without departing from the spirit or scope of the subject matter presented here. It will be readily understood that the aspects of the present disclosure, as generally described herein, and illustrated in the figures, can be arranged, substituted, combined, and designed in a wide variety of different configurations, all of which are explicitly contemplated and made part of this disclosure.

### DETAILED DESCRIPTION

Embodiments described herein pertain to systems and methods for manufacturing multi-layered porous materials (e.g., multi-layered porous films) including two or more layers of nanofibers adhered together to achieve a predetermined thickness. In some embodiments, the multi-layered porous materials are per-and polyfluoroalkyl substances (PFAS) free, i.e., do not include PFAS substances. In some embodiments, the multi-layered porous materials can be configured or formulated to be vapor permeable and/or waterproof, which makes the multi-layered porous materials described herein beneficial for the textile industry.

Embodiments described herein pertain to techniques for fabricating coupled porous films. In some aspects, a method can include disposing a first porous material onto a first carrier member, and coupling the first porous material to a second porous material to obtain a coupled porous material. The method further includes removing the first carrier member from the coupled porous material to obtain a coupled porous film. The method may also include disposing the second porous material onto a second carrier member prior to coupling the first porous material to the second porous material. In some cases, the method further includes removing the second carrier member from the coupled porous material. The method is conducted in a controlled environment, maintaining specific temperature and humidity conditions. In some embodiments, the coupling the first porous material to a second porous material includes bonding the first porous material to the second porous material.

Nanofibers are used in a wide range of applications due to their unique properties such as, for example, high surface area to weight ratio, low density, high pore volume, small pore size, superior stiffness, and higher tensile strength as compared to conventional fibers. Electrospinning is a versatile and scalable fabrication technique that can be used to produce nanoscale fibers with diameters ranging from a few nanometers up to micrometers. In a typical electrospinning process, a high voltage is applied to a polymer solution or melt loaded in a syringe. When the electrical forces overcome the surface tension of the liquid or melt, a charged jet or stream is ejected from the tip of the syringe, orifice, or nozzle. As the jet travels in the air, one of two things generally occur: for techniques using a polymer solution, solvent(s) included in the polymer solution evaporate as the jet travels, leaving behind thin solid fibers; for melt electrospinning or other solvent-free techniques, the polymer stream or jet undergoes solidification as it travels, without any solvent evaporation involved. In both cases, the solidified nanofibers can be collected on a carrier member (e.g., a carrier layer, or spool). The nanofibers can be stacked on the carrier member to form a porous nanofiber web, for example, a porous nanofiber thin layer.

Electrospun nanofibrous webs are widely employed in various applications due to their specific surface area and porous structure with narrow pore size. However, a challenge with electrospun nanofibers is their poor mechanical strength due to low contact and adhesion between the fibers. Several methods have been developed to provide suitable mechanical strength to electrospun nanofibers, with one common approach being the forming of multi-layered nanofibers, where multiple layers of nanofibers are bonded to achieve a certain thickness. Creating multi-layered nanofiber webs using, for example, lamination can improve the mechanical strength of nanofiber webs.

In prevalent production methods, nanofibers are electrospun onto a carrier member (e.g., a support member) to create electrospun nanofibrous webs. Once the nanofibers have been electrospun onto the carrier, the electrospun nanofibers generally are separated from the carrier member before they undergo bonding to other nanofiber layers, to achieve a nanofiber film or layer having a desired thickness. This is a delicate process as the thinness of the nanofibers often causes them to stick to the carrier and become damaged during the separation process. Therefore, after separating the nanofibers from the carrier, nanofibers are generally inspected, are repaired, and/damaged areas are excluded (e.g., cut out) if the damage is small. This separation, inspection, and repair process consumes a significant amount of processing time, increases manufacturing cost, and also has a considerable negative impact on product quality. Accordingly, bonding of nanolayers after separating from carrier members can be time-consuming and complex, and may include careful handling of the nanofibers at each step to prevent damage to nanofiber layers, and ensure the quality of the final product.

In contrast, embodiments described herein inhibit damage to nanofibers, for example electrospun nanofibers by bonding nanofiber layers to each other before separating nanofiber layers from a carrier member(s) on which the nanofiber(s) is disposed, instead of separating the nanofibers from the carrier member before bonding. Since bonded nanofibers are thicker and have higher mechanical strength, utilizing the bond strength of the two or more bonded layers of nanofibers, damage to the nanofibers during separation from the carrier member is reduced or limited. Thus, time and costs involved during subsequent inspection and repair processes may be reduced, reducing fabrication time, and increasing quality of the obtained nanofiber films.

Accordingly, the systems and methods provided herein may provide one or more benefits including, for example: (1) reducing manufacturing time; (2) increasing product quality by mitigating damages to the nanofiber; (3) decreasing cost of the manufacturing process by reducing wasted nanofibers which are removed from a production line due to damages the fibers have; (4) reducing the manufacturing steps and thereby, complexity by reducing or eliminating the process of treating and/or repairing the damaged sections of nanofibers; and (5) enabling handling of sticky nanofibers such as PFAS-free nanofibers.

Systems and methods described herein can be used for production of a multi-layered porous film (e.g., a coupled film) including two or more layers of nanofibers coupled (e.g., bonded, adhered, interlocked, connected, etc.) to each other. In some embodiments, each layer of the nanofibers may be include or be in the form of a fibrous web having a plurality of pores. In some embodiments, the multi-layered porous film can be a PFAS-free multi-layered porous film. In some embodiments, the multi-layered porous film can be a PFAS-free breathable and/or water-proof film, useful in textile industry.

As used in this specification, the singular forms “a,” “an,” and “the” include plural referents unless the context clearly dictates otherwise. Thus, for example, the term “a member” is intended to mean a single member or a combination of members, “a material” is intended to mean one or more materials, or a combination thereof.

The term “substantially” when used in connection with “cylindrical,” “linear,” and/or other geometric relationships is intended to convey that the structure so defined is nominally cylindrical, linear or the like. As one example, a portion of a support member that is described as being “substantially linear” is intended to convey that, although linearity of the portion is desirable, some non-linearity can occur in a “substantially linear” portion. Such non-linearity can result from manufacturing tolerances, or other practical considerations (such as, for example, the pressure or force applied to the support member). Thus, a geometric construction modified by the term “substantially” includes such geometric properties within a tolerance of plus or minus 5% of the stated geometric construction. For example, a “substantially linear” portion is a portion that defines an axis or center line that is within plus or minus 5% of being linear.

As used herein, the term “set” and “plurality” can refer to multiple features or a singular feature with multiple parts. For example, when referring to a set of fibers, the set of fibers can be considered as one electrode with multiple portions, or the set of electrodes can be considered as multiple, distinct fibers. Thus, a set of portions or a plurality of portions may include multiple portions that are either continuous or discontinuous from each other. A plurality of particles or a plurality of materials can also be fabricated from multiple items that are produced separately and are later joined together (e.g., via mixing, an adhesive, or any suitable method).

As used herein, the term “film” generally denotes any kind of “thin” material, i.e. material which has an extension in two dimensions that is greater compared to the extension in the remaining dimension, e.g. by a factor of at least 10, or at least 100 or even more. The film may be homogeneous or non-homogeneous in terms of its chemical composition. The film may contain voids, i.e. sections of the film do not show any matter in a lateral cut, or, preferably, may not contain voids, i.e. be closed.

As used herein, the term “porous” refers to a material which has voids throughout the internal structure which form an interconnected or closed air path from one surface to the other.

As described herein, the term “nanofiber” refers to a fiber having a cross-sectional width, for example, diameter in a range of about 50 nm to about 600 nm, inclusive.

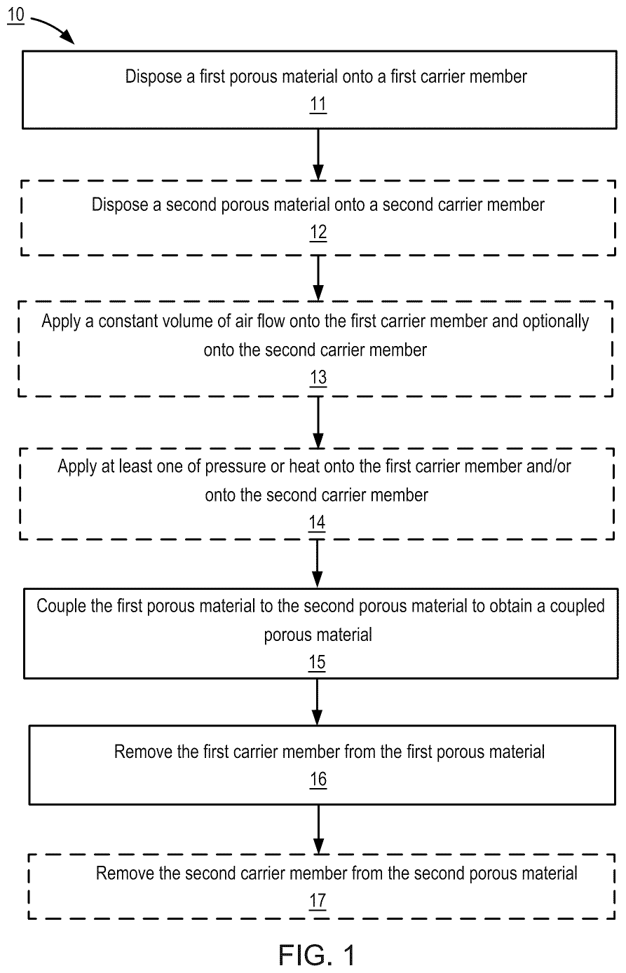

FIG. 1 is a block diagram of a method 10 for producing a coupled porous film, according to an embodiment. As shown, the method 10 includes disposing a first porous material onto a first carrier member, at 11. The method 10 can optionally include disposing a second porous material onto a second carrier member, at 12 and applying a constant volume of air flow onto the first carrier member and onto the second carrier member, at 13. The method can further include applying at least one of a pre-determined amount of pressure or a pre-determined amount of heat onto the first carrier member and onto the second carrier member, at 14. The method 10 includes coupling the first porous material to a second porous material to obtain a coupled porous material, at 5. The method 10 further includes removing the first carrier member from the coupled porous material, at 16 to obtain a coupled porous film. In some embodiments, the method 10 further includes removing the second carrier member from the coupled porous material, at 17.

In some embodiments, the method 10 is carried out in a controlled environment, for example, a temperature and/or humidity controlled environment, with specific temperature and humidity conditions maintained within a facility, such as a temperature and/or humidity controlled room, chamber, or compartment. That is, in some embodiments, at least one of a temperature or a relative humidity of a closed environment where operations of the method 10 are performed can be maintained at a constant level throughout the method 10. The method 10 can be performed in a batch, continuous, or semi-continuous fashion.

In some embodiments, the controlled environment has a temperature of at least about 20° C., at least about 21° C., at least about 22° C., at least about 23° C., at least about 24° C., at least about 25° C., at least about 26° C., at least about 27° C., at least about 28° C., at least about 29° C., at least about 30°° C., at least about 31° C., at least about 32° C., at least about 33° C., at least about 34° C., at least about 35° C., at least about 36° C., at least about 37° C., at least about 38° C., or at least about 39°° C. In some embodiments, the controlled environment has a temperature of no more than about 40° C., no more than about 39° C., no more than about 38° C., no more than about 37° C., no more than about 36° C., no more than about 35° C., no more than about 34° C., no more than about 33° C., no more than about 32° C., no more than about 31° C., no more than about 30° C., no more than about 29° C., no more than about 28° C., no more than about 27° C., no more than about 26° C., no more than about 25° C., no more than about 24° C., no more than about 23° C., no more than about 22° C., no more than about 21° C., or no more than about 20° C. Combinations of the above-referenced temperatures are also possible (e.g., at least about 20° C. and no more than about 40° C. or at least about 25° C. and no more than about 35−° C.), inclusive of all values and ranges therebetween. In some embodiments, the controlled environment has a temperature of about 20° C., about 21° C., about 22° C., about 23° C., about 24° C., about 25° C., about 26° C., about 27° C., about 28° C., about 29°° C., about 30° C., about 31° C., about 32° C., about 33° C., about 34° C., about 35° C., about 36° C., about 37° C., about 38° C., about 39° C., or about 40° C.

In some embodiments, the controlled environment maintains a relative humidity of at least about 45%, at least about 50%, at least about 55%, at least about 60%, at least about 65%, at least about 70%, or at least about 75. In some embodiments, the controlled environment maintains a relative humidity of no more than about 75%, no more than about 70%, no more than about 65%, no more than about 60%, no more than about 55%, no more than about 50%, no more than about 45%, no more than about 40%, no more than about 35%, no more than about 30%, no more than about 25%, no more than about 20%, or no more than about 15%. Combinations of the above-referenced relative humidity values are also possible (e.g., at least about 45% and no more than about 75% or at least about 30% and no more than about 70%), inclusive of all values and ranges therebetween. In some embodiments, the controlled environment has a relative humidity of about 30%, about 35%, about 40% 45%, about 50%, about 55%, about 60%, about 65%, about 70%, or about 75%,. As used herein, the term “relative humidity” refers to the ratio of the partial pressure of water vapor in the gas phase to the saturated vapor pressure of water at the temperature of the processing atmosphere.

At 11, the first porous material is disposed on the first carrier member. In some embodiments, the disposing can include disposing a plurality of nanofibers on the first carrier member using electrospinning. In some embodiments, the plurality of electrospun nanofibers are free of PFAS substances. In some embodiments, the operation 11 can include electrospinning a polymeric solution from a nozzle on the first carrier member. In some embodiments, the polymeric solution may include a polyurethane (PU) based solution with solvents and additives. The electrospinning method may be any one of general electrospinning techniques such as air electrospinning (AES), centrifugal electrospinning, flash-electrospinning, bottom up electrospinning, and/or top down electrospinning.

In some embodiments, the first carrier member may include a material that is fed from a spool or roll as the first porous material is being disposed thereon. In some embodiments, the feed speed or travel velocity of the first carrier member may be adjusted to control a thickness, porosity, porosity, or any other parameter of the first porous material collected thereon. In some embodiments, an adhesive may be disposed on the first carrier member to cause the disposed first nanofiber layer to adhere to the first carrier member. In some embodiments, the first porous material may be partially solidified when being deposited on the first carrier member, and may completely solidify or cure after being deposited on the first carrier member. In some embodiments, the first porous material may at least partially adhere to the first carrier member during curing, setting, or solidification of the first porous material on the first carrier member. In some embodiments, the first porous material may adhere to the first carrier member via stiction or non-covalent interactions. In some embodiments, the first carrier member with the first porous material disposed thereon may be collected on a spool or roll.

In some embodiments, at operation 11, the first porous material can be disposed on the first carrier member by electrospinning a first polymer solution (i.e., a solution of a first polymer) in which a first polymer and a first solvent are mixed. In some embodiments, the first porous material can be disposed on the first carrier member by electrospinning a first polymer melt (i.e., melt of a first polymer) on the first carrier member. In some embodiments, the first polymer may include two or more polymers having different physicochemical properties. In some embodiments, the first polymer is free of PFAS. In some embodiments, the first polymer can include a thermoplastic and/or thermosetting polymer(s) capable of being electrospun. In some embodiments, the first polymer can include a hydrophilic polymer or a hydrophobic polymer. In some embodiments, the first polymer can include polyurethane and/or its copolymers such as polyetherurethane, cellulose acetate, cellulose acetate butyrate, cellulose acetate propionate, or any other suitable polymer, or any suitable combination thereof.

In some embodiments, the first porous material includes or is in a form of a nanofiber web. As used herein, the term “nanofiber web”, refers to a film formed from a plurality of nanofibers (e.g., electrospun fibers) that are stacked on top of each other. The nanofiber web can be formed by electrospinning a polymer solution or a polymer melt on a carrier member. In some embodiments, the nanofiber web can be formed with a defined porosity, i.e., at least with a defined pore size and/or pore distribution.

In some embodiments, the first porous material includes a plurality of nanofibers. In some embodiments, the nanofibers have a thickness of at least about 250 nm, at least about 300 nm, at least about 350 nm, at least about 400 nm, at least about 450 nm, at least about 500 nm, at least about 550 nm, at least about 600 nm, or at least about 650 nm. In some embodiments, the nanofibers have a thickness of no more than about 1 um, no more than about 950 nm, no more than about 900 nm, no more than about 850 nm, no more than about 800 nm, no more than about 750 nm, no more than about 700 nm, or no more than about 650 nm, no more than about 600 nm, no more than about 550 nm, no more than about 500 nm, no more than about 450 nm, no more than about 400 nm, no more than about 350 nm, or no more than about 300 nm. Combinations of the above-referenced thicknesses are also possible (e.g., at least about 250 nm and no more than about 650 nm, at least about 300 nm and no more than about 600 nm, or at least about 100 nm and no more than about 1 μm), inclusive of all values and ranges therebetween.

As used herein, the term “fiber thickness” refers to the average fiber thickness (e.g., diameter) of the plurality of nanofibers included in a nanofiber web.

In some embodiments, the first porous material can have an average pore size of at least about 100 nm, at least about 200 nm, at least about 300 nm, at least about 400 nm, at least about 500 nm, or at least about 600 nm. In some embodiments, the first porous material can have an average pore size of no more than about 600 nm, no more than about 500 nm, no more than about 400 nm, no more than about 300 nm, no more than about 200 nm, no more than about 100 nm. Combinations of the above-referenced pore sizes are also possible (e.g., at least about 100 nm and no more than about 600 nm, or at least about 200 nm and no more than about 500 nm), inclusive of all values and ranges therebetween.

In some embodiments, the first carrier member can act as a stabilizing and/or protective layer for the first porous material. In some embodiments, the first carrier member can be a textile, a woven such as a monofilament or knitted fabric, or nonwovens. The first carrier member can have various properties such as being hydrophobic, oleophobic, repellent against sweat, blood, allergens, pathogens, flame retardant, and/or anti-static. In some embodiments, the first carrier member may include a polymer, a plastic, cellulose, or a composite material.

In some embodiments, the first carrier member can be a conventional support used for electrospinning nanofibers. The first carrier member may include various materials, each offering a supporting and/or protective function. In some embodiments, the first carrier member may including a cellulosic material, for example, paper or cardboard, which can serve as a stable and porous surface conducive to fiber deposition. In some embodiments, the first carrier member may include textiles, that may be woven and/or non-woven, which may provide versatility in surface texture and mechanical properties. In some embodiments, the first carrier member may include solid surfaces like glass slides or silicon wafers, which may offer precise control over fiber alignment and distribution, for example, for applications requiring defined patterning or surface modification. Additionally, the first carrier member can take the form of a mesh or screen, enhancing structural support and airflow.

In some embodiments, the first carrier member can be coupled to the first porous material. In some embodiments, the first carrier member can be bonded to the first porous material by methods well known in the art, including but not limited to reactive hot-melt bonding, laser bonding, ultrasonic welding, lamination, thermal calendering, gluing, or a combination thereof. For example, the hotmelt-bonding can be carried out with an adhesive (e.g., an epoxy, acrylate and/or polyurethane adhesives).

In certain embodiments where the first porous material is PFAS-free, the first carrier member aids in the handling and transfer of the material. This assistance is particularly beneficial because PFAS-free materials exhibit a higher degree of adhesion compared to PFAS-containing counterparts, resulting in increased stickiness and necessitating additional support during processing. However, the higher degree of adhesion of such materials to the first carrier member also makes it more challenging to remove the disposed first porous material from the first carrier member.

In some embodiments, the method 10 may include disposing a second porous material onto a second carrier member, at 12. This step can be performed in a similar or substantially the same way as operation 11. The second porous material and the second carrier member can be prepared in a manner similar to the methods described above for the first porous material and the first carrier member. Accordingly, the second porous material and the second carrier member can be similar or substantially the same as the first porous material and the first carrier member described with respect to operation 11.

In some embodiments, the first porous material and the second porous material can have differing material compositions. In some embodiments, the first porous material and the second porous material can have differing textures. In some embodiments, the first porous material and the second porous material can have similar or substantially same material compositions. In some embodiments, at least one of the first porous material and the second porous material is obtained via electrospinning.

In some embodiments, the first carrier member and the second carrier member can have differing material compositions. In some embodiments, the first carrier member and the second carrier member can have similar or substantially same material compositions.

In some embodiments, at operation 12, the second porous material can be disposed on the second carrier member by electrospinning a second polymer solution (i.e., a solution of a second polymer) in which a second polymer and a second solvent are mixed. In some embodiments, the second porous material can be disposed on the second carrier member by electrospinning a second polymer melt (i.e., melt of a second polymer) on the second carrier member. In some embodiments, the second polymer may include two or more polymers having different physicochemical properties. In some embodiments, the second polymer is free of PFAS. In some embodiments, the second polymer can include thermoplastic and/or thermosetting polymers capable of being electrospun. In some embodiments, the second polymer can include a hydrophilic polymer or a hydrophobic polymers. In some embodiments, the second polymer can include polyurethane and/or its copolymers such as polyetherurethane, cellulose acetate, cellulose acetate butyrate, cellulose acetate propionate, or any other suitable polymer, or any suitable combination thereof.

In some embodiments, the first polymer and the second polymer may have similar or substantially similar chemical compositions. In some embodiments, the first polymer and the second polymer may have different chemical compositions. In some embodiments, the first polymer and the second polymer may differ in one or more physicochemical properties, including, but not limited to, molecular weight, glass transition temperature, crystallinity, viscosity, solubility, thermal stability, and/or other structural or compositional characteristics. In some embodiments, the first polymer and the second polymer may exhibit one or more physicochemical properties that are similar or substantially same. In some embodiments, the selection of the first and second polymers may be made to achieve a desired combination of similarities and differences in chemical composition and/or physicochemical properties.

At operation 13, a constant volume of air flow can be blown onto at least one of the first carrier member and the second carrier member at a constant temperature and humidity. In some embodiments, when the carrier member is not configured to allow airflow through the first and second porous materials, a constant volume of air flow can be blown onto at least one of the first porous material or second porous material. The airflow can be directed onto the carrier members using any suitable apparatus such as, for example, an air knife, a blower, a nozzle, etc. The air flow can have a flow rate ranging from about 0.1 cubic feet per minutes (CFM) to about 10 CFM, inclusive. In some air flow rate can have a flow rate of at least about 0.1 CFM, at least about 0.5 CFM, at least about 1 CFM, at least about 2 CFM, at least about 3 CFM, at least about 4 CFM, at least about 5 CFM, at least about 6 CFM, at least about 7 CFM, at least about 8 CFM, or at least about 9 CFM. In some embodiments, the air flow can have a flow rate of no more than about 10 CFM, no more than about 9 CFM, no more than about 8 CFM, no more than about 7 CFM, no more than about 6 CFM, no more than about 5 CFM, no more than about 4 CFM, no more than about 3 CFM, no more than about 2 CFM, or no more than about 1 CFM. Combinations of the above-referenced pore sizes are also possible (e.g., at least about 0.1 CFM and no more than about 10 CFM, or at least about 1 CFM and no more than about 8 CFM), inclusive of all values and ranges therebetween. In some embodiments, the air flow has a flow rate of about 0.1 CFM, about 0.5 CFM, about 1 CFM, about 2 CFM, about 3 CFM, about 4 CFM, about 5 CFM, about 6 CFM, about 7 CFM, about 8 CFM, about 9 CFM, or about 10 CFM, inclusive.

The air flow can enhance coupling strength between the first porous material and the second porous material (e.g., the adhesive strength between the two nanofiber webs) as well as can facilitate the separation of the first porous material and the second porous material from the corresponding carriers. In some embodiments, the airflow can be heated to a predetermined temperature, for example, to heat or preheat the first porous material and/or the second porous material to a predetermined temperature.

The method 10 may also include applying at least one of a pre-determined amount of pressure or a pre-determined amount of heat onto the first porous material through the first carrier member, and the second porous material, for example, through the second carrier member, at 14, to facilitate coupling of the first porous material to the second porous material to form a coupled porous material. In some embodiments, operation 14 includes employing at least one of a pressure roll or a heating roll onto at least one of the first carrier member or the second carrier member. In some embodiments, applying at least one of a pre-determined amount of pressure or a pre-determined amount of heat onto the first carrier member and onto the second carrier member can include concurrently passing both the first carrier member and the second carrier member through a nip region between rollers of a roller assembly such that the first porous material and the second porous material come, are urged to, or caused to be in contact with each other.

In some embodiments, the roller assembly includes at least one of a heating roller or a pressure-applying roller. In some embodiments, a surface of the heating roll is surface-treated to uniformly heat the surface temperature of the porous materials. In some embodiments, the temperature of the heating roll is configured to remain uniform and constant during operation 14.

In some embodiments, a pressure exerted by the pressure-applying roller can be adjusted with respect to the thickness of the first porous material and the second porous material. In some embodiments, heated air, for example, provided by the air knives, blowers, or any suitable equipment described herein, may be used to apply the predetermined heat to the first porous material and/or the second porous material, and the rollers may be used solely for applying the predetermined pressure on the first and a second porous materials.

At operation 15, in some embodiments, the coupling the first porous material to a second porous material includes bonding the first porous material to the second porous material. In some embodiments, the first porous material and the second porous material can be bonded to each other using any suitable method such as, for example, via added adhesive, heat, pressure, or inherent adhesion properties of one of the first porous material or the second porous material. In some embodiments, the first porous material and the second porous material are bonded by pressure bonding by rolling or pressing, for example, as the first and second porous materials pass through the nip region of the rollers. In some embodiments, the first porous material and the second porous material are bonded by thermal bonding via applying a pre-determined heat onto at least one of the first porous material or the second porous material. The thermal bonding can achieved by increasing the temperature of at least one of the first porous material or the second porous material to the adhesive softening temperature at which softening of at least one of the first porous material or the second porous material occurs. When at least one of the first porous material and the second porous material softens, at least one of the first porous material or the second porous material exhibits an adhesive effect, i.e., acts like an adhesive so that at least part of the first porous material and/or the second porous material are thermally bonded to each other.

In some embodiments, a top portion of the first porous material and/or the second porous material can include a stimuli-responsive adhesive layer, which becomes adherent when a stimulus (e.g., heat, pressure, ultraviolet light, etc.) is applied to the adhesive layer such that the first porous material and the second porous material can bind to each other via the adhesive layer.

At operation 16, the first carrier member is removed from the coupled porous material to yield a coupled porous film. In some embodiments, this removal is achieved by mechanically stripping or pulling the first carrier member from the first porous material. If a predetermined amount of pressure was applied during operation 15, the pressure can be adjusted to facilitate the separation. The pressure may be changed (e.g., decreased) based on the thickness of the first porous material. Similarly, if heat was applied during operation 15, the temperature of the first porous material and/or the first carrier member can be maintained constant or adjusted (increased or decreased) to aid in the separation process.

In some embodiments in which the second porous material is disposed on the second carrier member, the method 10 includes the removal of the second carrier member from the second porous material, at operation 17. In some embodiments, operation 17 can be similar or substantially the same as the operation 16. In some embodiments, the second porous material may be removed from the second carrier member concurrently with the first porous material being removed from the first carrier member. Coupling the first porous material to the second porous material yields the coupled porous material that has a higher thickness and strength than each of the individual first and a second porous materials. The higher strength of the coupled porous material makes it much less susceptible to damage during removal of the first carrier member and, in some embodiments, the second carrier member therefrom. Thus, the coupled porous film obtained using method 10 may require less post processing operations, less manufacturing time, lower cost, and may also have higher fiber quality.

In some embodiments, the coupled porous film may have a moisture permeability of 10,000 to 50,000 g/m², inclusive, per 24 h according to the calcium chloride method (A-1 method) of JIS L1099, and an air permeability of about 0.1 CFM to about 10 CFM, inclusive. Accordingly, the coupled porous film obtained herein by employing method 10 can be beneficial as a textile. In some embodiments, the coupled porous film provided herein suitable as a waterproof/breathable and/or windproof interlining for fabrics and clothes, and can be widely used for hats, gloves, shoes and the like.

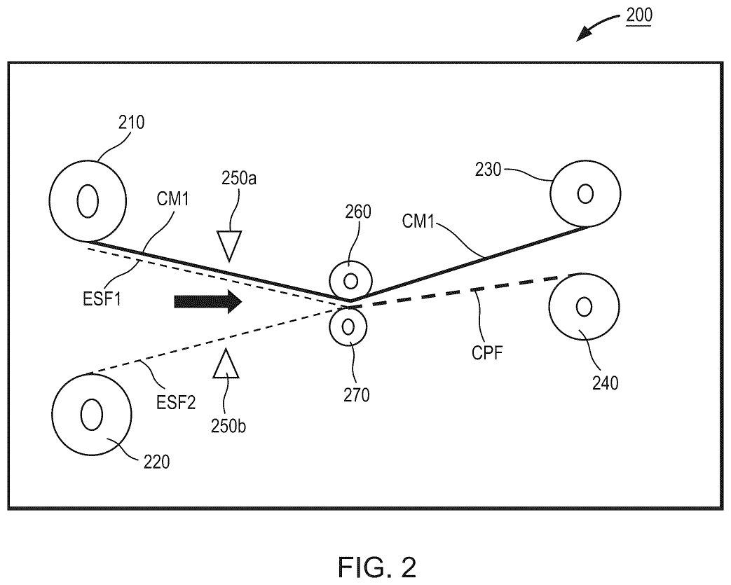

FIG. 2 shows an illustration of a system 200 for manufacturing a coupled porous film including a plurality of nanofibers, according to an embodiment. In some embodiments, the system 200 can be used to implement method 10 as described in FIG. 1.

The system 200 includes a first nanofiber roll 210 and a second nanofiber roll 220 facing each other as shown in FIG. 2. The system 200 further includes a carrier roll 230, a product roll 240, a first air knife 250a, a second air knife 250b, a heating roller 260, and a pressure roller 270, as illustrated in FIG. 2. System 200 operates within a controlled environment, as described above with respect to method 10, that maintains a constant temperature and humidity.

The first nanofiber roll 210 includes a first plurality of electrospun fibers ESF1 disposed on a first carrier member CM1 wound around the first nanofiber roll 210. In some embodiments, the first nanofiber roll 210 is physically connected to the carrier roll 230 such that first plurality of electrospun fibers ESF1 disposed on the first carrier member CMI can be conveyed through a nip region between the heating roller 260 and the pressure roller 270.

The second nanofiber roll 220 includes a second plurality of electrospun fibers ESF2 wound around the second nanofiber roll 220. In some embodiments, the second nanofiber roll 220 can be physically connected to the product roll 240 such that the second plurality of electrospun fibers ESF2 can be conveyed from the second nanofiber roll 220 through the nip region between the heating roller 260 and the pressure roller 270. While shown as including a heating roller 260 and the pressure roller 270, in some embodiments, each of the rollers 260 and 270 may be configured to apply heat and pressure on the first plurality of electrospun fibers ESF1 and the second plurality of electrospun fibers ESF2.

In some embodiments, the first plurality of electrospun fibers ESF1 and the second plurality of electrospun fibers ESF2 can have differing compositions. In some embodiments, the first plurality of electrospun fibers ESF1 and the second plurality of electrospun fibers ESF2 can have differing physicochemical properties (e.g., thickness, concentration, arrangement, functionality of nanofiber). In some embodiments, the first plurality of electrospun fibers ESF1 and the second plurality of electrospun fibers ESF2 can have similar or substantially same compositions.

The air knife 250a is configured to blow a predetermined volume of air onto the first carrier member CM1. The air knife 250b is configured to blow a predetermined volume of air onto the second plurality of electrospun fibers ESF2. The air knives 250a, 250b are configured to blow a constant flow of air at a constant temperature and humidity. The air blown through the air knives 250a, 260b can enhance the bonding between the first plurality of electrospun fibers ESF1 and the second plurality of electrospun fibers ESF2. Further, in some embodiments, the air blown through the air knives 250a, 260b can facilitate the separation of the first plurality of electrospun fibers ESF1 from the first carrier member CM 1.

Once the first plurality of electrospun fibers EST1 and the second plurality of electrospun fibers ESF2 are conveyed through the nip region between the heating roller 260 and the pressure roller 270, the first plurality of electrospun fibers ESF1 and the second plurality of electrospun fibers ESF2 can bind to each other to form a coupled porous material similar to or substantially same as the coupled porous material described with respect to FIG. 1.

The heating roller 260 is configured to apply uniform heat onto the first carrier member CM1 at a controlled speed, ensuring proper bonding of the ESF1 and the ESF2. The first carrier member CM1 can be formed into such a thickness that the first carrier member CM1 can transfer the heat provided by the heating roller 260 to the first plurality of electrospun fibers ESF1. The pressure roller 270 is configured to apply a pre-determined pressure onto the second plurality of electrospun fibers ESF2 to facilitate bonding of the ESF1 and the ESF2. In some embodiments, after bonding occurs within the nip region between the heating roller 260 and the pressure roller 270, the pressure applied by the pressure roller 270 can be decreased in order to start the separation process of the coupled porous material from the first carrier member CM1.

In some embodiments, the carrier roll 230 is configured to pull the first carrier member CM1 from the coupled porous material and wind around the roll such that the first carrier member CMI can be separated from the coupled porous material to form a coupled porous film CPF. In some embodiments, the coupled porous film produced by the system 200 can be similar or substantially the same as the coupled porous film described in method 10.

The product roll 240 is configured to pull the coupled porous film CPF such that the coupled porous film CPF can be wound around the product roll 240, as well as cause the coupled porous film CPF to separate from the first carrier member CM1. That is, the product roll can exert a pulling force on the coupled porous film CPF. This pulling can enable the coupled porous film CPF to be wound around the product roll, ensuring a smooth and continuous production process.

In some embodiments, both the carrier roll 230 and the product roll 240 can be mechanically coupled to a motor. This connection can be facilitated through a shaft or a similar mechanical component. The motor provides the necessary rotational force, driving both the carrier roll 230 and the product roll 240.

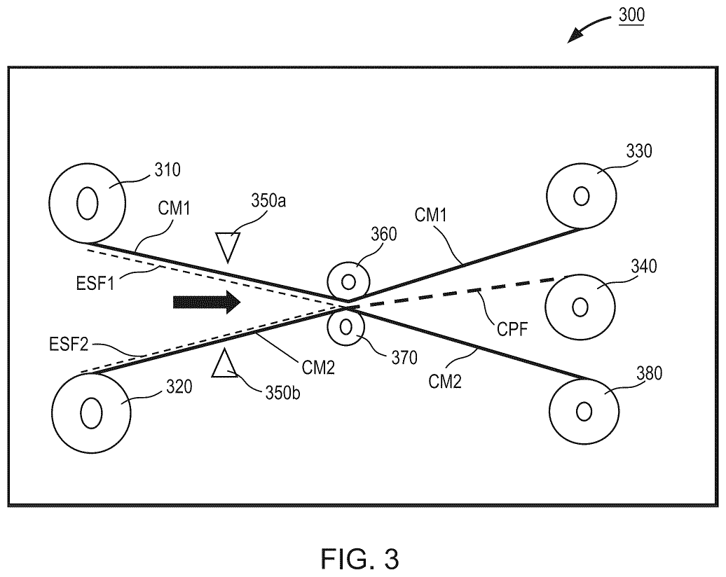

FIG. 3 shows an illustration of a system 300 for manufacturing a coupled porous film including a plurality of nanofibers, according to an embodiment. In some embodiments, the system 300 can be used to implement method 10 as described in FIG. 1. The system 200 includes a first nanofiber roll 310 and a second nanofiber roll 320 facing each other as shown in FIG. 3. The system 300 may further include a first carrier roll 330, a second carrier roll 380, a product roll 340, a first air knife 350a, a second air knife 350b, a heating roller 360, and a pressure roller 370, as illustrated in FIG. 3. The system 300 includes all components of the system 200, and operates in a similar manner as the system 200. However, the system 300 includes an additional second carrier roller 380. Further, in system 300, the second nanofiber roll 320 includes a second plurality of electrospun fibers ESF2 disposed on a second carrier member CM2 wound around the second nanofiber roll 320.

In some embodiments, the first carrier roll 330, the product roll 340, the first air knife 350a, the second air knife 350b, and the heating roller 360 are similar or substantially the same as the first carrier roll 230, the product roll 240, the first air knife 250a, the second air knife 250b, and the heating roller 260 of the system 200 as described with respect to FIG. 2.

In some embodiments, the second nanofiber roll 320 can be physically coupled or connected to the second carrier roll 380 such that the second plurality of electrospun fibers ESF2 disposed on the second carrier member CM2 can be conveyed through a nip region between the heating roller 360 and the pressure roller 370.

The pressure roller 370 is configured to apply a pre-determined pressure onto the second carrier member CM2 to facilitate bonding of first plurality of electrospun fibers ESF1 disposed on the first carrier member CM1 and the second plurality of electrospun fibers ESF2 disposed on the second carrier member CM2.

The second carrier roll 380 is configured to pull the second carrier member CM2 from the coupled porous material and wind around the roll such that the second carrier member CM2 can be separated from the coupled porous material yielding a coupled porous film CPF. In some embodiments, the coupled porous film produced by the system 300 can be similar or substantially the same as the coupled porous film described in method 10.

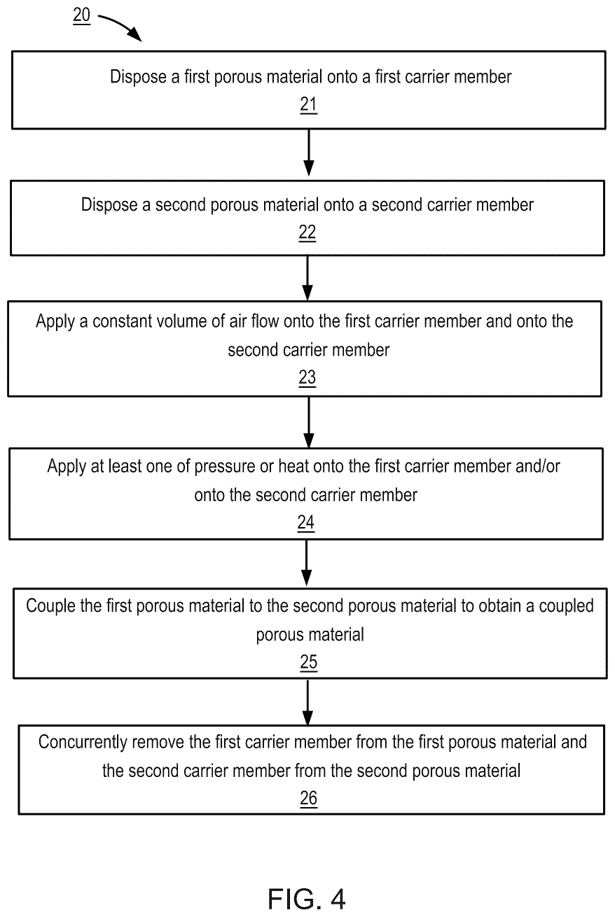

FIG. 4 is a block diagram of a method 20 for producing a coupled porous film, according to an embodiment. As shown, the method 20 includes disposing a first porous material onto a first carrier member, at 21 and disposing a second porous material onto a second carrier member, at 22. The method 20 further includes applying a constant volume of air flow onto the first carrier member and onto the second carrier member, at 23, and applying at least one of a pre-determined amount of pressure or a pre-determined amount of heat onto at least one of the first carrier member and onto the second carrier member, at 24. The method 20 includes coupling the first porous material to a second porous material to obtain a coupled porous material, at 25 and concurrently removing the first carrier member from the first porous material and the second carrier member from the second porous material, at 26. In some embodiments, the method 20 can be performed by implementing the system 300 described with respect to FIG. 3.

In some embodiments, the first porous material, the second porous material, the coupled porous material, and the coupled porous film, are similar or substantially same as the first porous material, the second porous material, the coupled porous material, and the coupled porous film, described above with respect to FIG. 1.

In some embodiments, the method 20 can involve using two nanofiber rolls, each including a plurality of nanofibers electrospun onto a carrier member, arranged facing each other for bonding. The nanofibers disposed on the carrier members can then passed between a press roll and a heating roll, which may be specially surface-treated to uniformly heat the surface temperature, at a prescribed speed to bond them. Following bonding, the nanofibers are separated from the carrier, resulting in two carrier rolls and one bonded nanofiber roll. The method 20 includes a process that separates the carrier member and nanofiber after bonding, instead of separating from the carrier before bonding. In some embodiments, the method 20 can include a separation process after bonding under altered temperature and humidity conditions than the bonding conditions.

The method 20 allows for changes in the pressing force (i.e., the pressure applied onto at least one of the first carrier member or the second carrier member) to facilitate bonding, modifications to the heat source of the heating roll, and temperature adjustments in the separation process after bonding.

Various concepts may be embodied as one or more methods, of which at least one example has been provided. The acts performed as part of the method may be ordered in any suitable way. Accordingly, embodiments may be constructed in which acts are performed in an order different than illustrated, which may include performing some acts simultaneously, even though shown as sequential acts in illustrative embodiments. Put differently, it is to be understood that such features may not necessarily be limited to a particular order of execution, but rather, any number of threads, processes, services, servers, and/or the like that may execute serially, asynchronously, concurrently, in parallel, simultaneously, synchronously, and/or the like in a manner consistent with the disclosure. As such, some of these features may be mutually contradictory, in that they cannot be simultaneously present in a single embodiment. Similarly, some features are applicable to one aspect of the innovations, and inapplicable to others.

In addition, the disclosure may include other innovations not presently described. Applicant reserves all rights in such innovations, including the right to embodiment such innovations, file additional applications, continuations, continuations-in-part, divisionals, and/or the like thereof. As such, it should be understood that advantages, embodiments, examples, functional, features, logical, operational, organizational, structural, topological, and/or other aspects of the disclosure are not to be considered limitations on the disclosure as defined by the embodiments or limitations on equivalents to the embodiments. Depending on the particular desires and/or characteristics of an individual and/or enterprise user, database configuration and/or relational model, data type, data transmission and/or network framework, syntax structure, and/or the like, various embodiments of the technology disclosed herein may be implemented in a manner that enables a great deal of flexibility and customization as described herein.

All definitions, as defined and used herein, should be understood to control over dictionary definitions, definitions in documents incorporated by reference, and/or ordinary meanings of the defined terms.

As used herein, in particular embodiments, the terms “about” or “approximately” when preceding a numerical value indicates the value plus or minus a range of 10%. Where a range of values is provided, it is understood that each intervening value, to the tenth of the unit of the lower limit unless the context clearly dictates otherwise, between the upper and lower limit of that range and any other stated or intervening value in that stated range is encompassed within the disclosure. That the upper and lower limits of these smaller ranges can independently be included in the smaller ranges is also encompassed within the disclosure, subject to any specifically excluded limit in the stated range. Where the stated range includes one or both of the limits, ranges excluding either or both of those included limits are also included in the disclosure.

The phrase “and/or,” as used herein in the specification and in the embodiments, should be understood to mean “either or both” of the elements so conjoined, i.e., elements that are conjunctively present in some cases and disjunctively present in other cases. Multiple elements listed with “and/or” should be construed in the same fashion, i.e., “one or more” of the elements so conjoined. Other elements may optionally be present other than the elements specifically identified by the “and/or” clause, whether related or unrelated to those elements specifically identified. Thus, as a non-limiting example, a reference to “A and/or B”, when used in conjunction with open-ended language such as “comprising” can refer, in one embodiment, to A only (optionally including elements other than B); in another embodiment, to B only (optionally including elements other than A); in yet another embodiment, to both A and B (optionally including other elements); etc.

As used herein in the specification and in the embodiments, “or” should be understood to have the same meaning as “and/or” as defined above. For example, when separating items in a list, “or” or “and/or” shall be interpreted as being inclusive, i.e., the inclusion of at least one, but also including more than one, of a number or list of elements, and, optionally, additional unlisted items. Only terms clearly indicated to the contrary, such as “only one of” or “exactly one of,” or, when used in the embodiments, “consisting of,” will refer to the inclusion of exactly one element of a number or list of elements. In general, the term “or” as used herein shall only be interpreted as indicating exclusive alternatives (i.e., “one or the other but not both”) when preceded by terms of exclusivity, such as “either,” “one of,” “only one of,” or “exactly one of.” “Consisting essentially of,” when used in the embodiments, shall have its ordinary meaning as used in the field of patent law.

As used herein in the specification and in the embodiments, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified. Thus, as a non-limiting example, “at least one of A and B” (or, equivalently, “at least one of A or B,” or, equivalently “at least one of A and/or B”) can refer, in one embodiment, to at least one, optionally including more than one, A, with no B present (and optionally including elements other than B); in another embodiment, to at least one, optionally including more than one, B, with no A present (and optionally including elements other than A); in yet another embodiment, to at least one, optionally including more than one, A, and at least one, optionally including more than one, B (and optionally including other elements); etc.

In the embodiments, as well as in the specification above, all transitional phrases such as “comprising,” “including,” “carrying,” “having,” “containing,” “involving,” “holding,” “composed of,” and the like are to be understood to be open-ended, i.e., to mean including but not limited to. Only the transitional phrases “consisting of” and “consisting essentially of” shall be closed or semi-closed transitional phrases, respectively, as set forth in the United States Patent Office Manual of Patent Examining Procedures, Section 2111.03.

While specific embodiments of the present disclosure have been outlined above, many alternatives, modifications, and variations will be apparent to those skilled in the art. Accordingly, the embodiments set forth herein are intended to be illustrative, not limiting. Various changes may be made without departing from the spirit and scope of the disclosure. Where methods and steps described above indicate certain events occurring in a certain order, those of ordinary skill in the art having the benefit of this disclosure would recognize that the ordering of certain steps may be modified and such modification are in accordance with the variations of the invention. Additionally, certain of the steps may be performed concurrently in a parallel process when possible, as well as performed sequentially as described above. The embodiments have been particularly shown and described, but it will be understood that various changes in form and details may be made.

1. A method, comprising:
disposing a first porous material onto a first carrier member;
coupling the first porous material to a second porous material to obtain a coupled porous material; and
removing the first carrier member from the coupled porous material to obtain a coupled porous film.

2. The method of claim 1, wherein disposing the first porous material onto the first carrier member includes electrospinning a first solution on the first carrier member.

3. The method of claim 1, further comprising:
prior to coupling the first porous material to the second porous material, disposing the second porous material onto a second carrier member.

4. The method of claim 3, wherein disposing the second porous material onto the second carrier member includes electrospinning a second solution on the second carrier member.

5. The method of claim 4, further comprising:
removing the second carrier member from the coupled porous material.

6. The method of claim 5, wherein the first carrier member and the second carrier member are removed concurrently from the coupled porous material to obtain the coupled porous film.

7. The method of claim 1, wherein coupling the first porous material to the second porous material comprises applying at least one of pressure or heat on the first carrier member.

8. The method of claim 7, wherein applying the at least one of pressure or heat onto the first carrier member and the second porous material includes concurrently passing the first carrier member and the second porous material through a nip region between rollers of a roller assembly to cause the first porous material and the second porous material to contact each other.

9. The method of claim 8, wherein the roller assembly comprises at least one of a heating roller or a pressure-applying roller.

10. The method of claim 1, further comprising:
applying a constant volume of air flow onto at least one of the first carrier member or the second porous material prior to coupling the first porous material to the second porous material.

11. The method of claim 1, wherein at least one of the first porous material or the second porous material does not include per-or polyfluoroalkyl substances.

12. The method of claim 1, wherein at least one of the first porous material or the second porous material comprises a nanofiber web, the nanofiber web including a plurality of nanofibers.

13. The method of claim 12, wherein the plurality of nanofibers have an average fiber thickness of about 100 nm to about 1 μm.

14. The method of claim 1, further comprising:
controlling at least one of a temperature or a relative humidity of an environment in which the first porous material, the second porous material, and the first carrier member are disposed.

15. The method of claim 14, wherein:
the temperature is maintained in a range from about 20° C. to about 40° C., and the relative humidity is maintained in range from about 30% to about 70%.

16. A method, comprising:
disposing a first porous material onto a first carrier member;
disposing a second porous material onto a second carrier member;
coupling the first porous material to a second porous material to obtain a coupled porous material;
removing the first carrier member from the coupled porous material; and
removing the second carrier member from the coupled porous material to obtain a coupled porous film.

17. The method of claim 16, wherein disposing the first porous material onto the first carrier member comprises electrospinning at least one of a first polymer solution or a first polymer melt onto the first carrier member.

18. The method of claim 17, wherein the at least one of the first polymer solution or the first polymer melt does not include per-or polyfluoroalkyl substances.

19. The method of claim 16, wherein disposing the second porous material onto the second carrier member comprises electrospinning at least one of a second polymer solution or a second polymer melt onto the second carrier member.

20. The method of claim 19, wherein the at least one of the second polymer solution or the second polymer melt does not include per-or polyfluoroalkyl substances.

21. The method of claim 16, wherein the first carrier member and the second carrier member are removed simultaneously from the coupled porous material to obtain the coupled porous film.

22. The method of claim 16, wherein coupling the first porous material to the second porous material includes applying at least one of pressure or heat on the first carrier member and the second carrier member.

23. The method of claim 22, wherein applying the at least one of pressure or heat onto the first carrier member and the second carrier material comprises concurrently passing the first carrier member and the second carrier member through a nip region between rollers of a roller assembly to cause the first porous material and the second porous material to contact each other.

24. The method of claim 16, wherein at least one of the first porous material or the second porous material includes a nanofiber web, the nanofiber web comprising a plurality of nanofibers.

25. The method of claim 24, wherein the plurality of nanofibers have an average fiber thickness in a range from about 100 nm to about 1 μm.

26. The method of claim 16, further comprising:
controlling at least one of a temperature or a relative humidity of an environment in which the first porous material, the second porous material, the first carrier member, and the second carrier member are disposed.

27. The method of claim 26, wherein:
the temperature is maintained in a range from about 20° C. to about 40° C., and the relative humidity is maintained in range from about 30% to about 70%.
